(19) United States
(12) Patent Application Publication
(10) Pub. No.: US 2022/0081601 A1
(43) Pub. Date: Mar. 17, 2022

(54) PHASE CHANGE HEAT STORAGE RUBBER, METHOD FOR PREPARING THE SAME, AND USING METHOD THEREOF

(71) Applicant: Liqiang Zhang, Huizhou (CN)

(72) Inventor: Liqiang Zhang, Huizhou (CN)

(21) Appl. No.: 17/536,172

(22) Filed: Nov. 29, 2021

Related U.S. Application Data
(63) Continuation-in-part of application No. PCT/CN2019/107370, filed on Sep. 23, 2019.

(30) Foreign Application Priority Data
Jul. 3, 2019 (CN) 201910595252.6

(51) Int. Cl. C09K 5/06; C08L 83/04; C08L 23/16; C08L 7/00; C08L 9/02; C08L 11/00; C08K 13/04; H01M 10/659; H01G 2/08

(52) U.S. Cl. CPC C09K 5/063; C08L 83/04; C08L 23/16; C08L 7/00; C08L 9/02; C08K 2003/385; C08K 13/04; H01M 10/659; H01G 2/08; C08L 2203/20; C08L 11/00

(57) ABSTRACT

A phase change heat storage rubber includes 20-70 parts by weight of rubber and 10-68 parts by weight of modified phase change powder. The rubber contains a suitable amount of the modified phase change powder, so that the phase change heat storage rubber has excellent heat absorption and heat storage performance. Its phase change enthalpy reaches 15-200 J/g, its specific heat capacity exceeds 2.0 J/g·K, satisfying the requirements of batteries and capacitors for heat absorption and heat storage performance. The modified phase change powder has heat absorption and energy storage functions. Because of a large phase change enthalpy value and a slow temperature rise, the phase change heat storage rubber may absorb more heat. The phase change powder has been modified by a modifier. The modifier is a powder that has a large specific surface area and contains micropores.

### CROSS-REFERENCE TO RELATED APPLICATIONS

The present application is a continuation in part of PCT application No. PCT/CN2019/107370, filed on Sep. 23, 2019, which designates United States and claims priority of China Patent Application No. 201910595252.6, filed on Jul. 3, 2019 which is incorporated herein by reference.

### BACKGROUND OF THE INVENTION

### 1. Field of the Invention

The present invention relates to a heat storage rubber and a method for preparing the same, more particularly, to a phase change heat storage rubber, a method for preparing the same, and using method thereof.

### 2. Description of Related Art

More compact and lightweight electronic products require a higher integration level, but in turn, a higher integration level worsens heat dissipation. Therefore, to prevent a heat spot resulting from heat accumulation, it is necessary to quickly transfer or store the heat of the heat spot. Now that a product is more compact and has even limited interior space, it usually adopts a heat conductive material to transfer the heat to a rubber shell made of, but the current rubber shell does not have a heat storage function, so it quickly reaches heat saturation, failing to enable continuous heat transfer and storage.

For example, a large-capacity lithium battery pack is composed of a plurality of lithium battery cells connected in series or parallel and generates a large amount of heat energy during charging and discharging, and how to transfer the heat energy to the rubber shell as soon as possible and thus enable the lithium battery to rapidly lower its temperature is a problem.

Similarly, the capacitor is easy to produce a large amount of heat after long-term use, a larger capacitor generates more heat, and how to transfer this heat energy to the rubber shell as soon as possible is also an urgent problem to be solved in the industry.

To solve the above-mentioned problems, a phase change material has been added to the rubber in the prior art; however, the phase change material may leak liquid at a high temperature, and the phase change material may dissociate from the matrix, which, on the one hand, increases the difficulty in the subsequent operation such as mixing and stir-shaping, on the other hand, greatly reduces the performance of the phase change heat storage rubber and affects the heat storage performance thereof.

Therefore, it is desirable to provide a phase change heat storage rubber, a method for preparing the same, and using method thereof to solve the problems of the prior art.

### DETAILED DESCRIPTION OF THE INVENTION

The invention will now be described in detail through several embodiments with reference to the accompanying drawings.

### Example 1

A phase change heat storage rubber includes the following components in parts by weight: 20 parts of NBR rubber, and 10 parts of modified phase change powder.

The modified phase change powder was prepared by: heating and melting a paraffin wax, adding expanded graphite to the melted paraffin wax in an amount of 2% by weight of the paraffin wax, then mixing the expanded graphite and the melted paraffin wax to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the expanded graphite completely to get a powder, then grinding the powder with a ball mill or a sand mill to obtain the modified phase change powder. Before grinding the powder, if there is unabsorbed melted paraffin wax after the mixture is vibrated, oil absorbing material, such as an oil absorbing paper or expanded graphite worms or aerogel.

### Example 2

A phase change heat storage rubber, includes the following components in parts by weight: 70 parts of NBR rubber, and 10 parts of modified phase change powder.

The modified phase change powder was prepared by: heating and melting a 60-carbon-atom alkane wax, adding a nano silica micro powder to the melted 60-carbon-atom alkane wax in an amount of 40% by weight of the 60-carbon-atom alkane wax, then mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 60-carbon-atom alkane wax can be absorbed by the nano silica micro powder completely to get a powder, then grinding the powder with a ball mill or a sand mill to obtain the modified phase change powder.

### Example 3

A phase change heat storage rubber, includes the following components in parts by weight: 40 parts of NBR rubber, and 50 parts of modified phase change powder.

The modified phase change powder was prepared by: heating and melting fatty acid, adding a hollow microsphere powder to the melted fatty acid in an amount of 20% by weight of the fatty acid, then mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the hollow microsphere powder completely to get a powder, then grinding the powder with a ball mill or a sand mill to obtain the modified phase change powder.

### Example 4

A phase change heat storage rubber, includes the following components in parts by weight: 60 parts of EPDM rubber, and 50 parts of modified phase change powder.

The modified phase change powder was prepared by: heating and melting a PE wax, adding nano silica micro powder to the melted PE wax in an amount of 10% by weight of the PE wax, then mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted PE wax can be absorbed by the nano silica micro powder completely to get a powder, then grinding the powder with a ball mill or a sand mill to obtain the modified phase change powder.

### Example 5

A phase change heat storage rubber, includes the following components in parts by weight: 40 parts of silicone rubber, and 30 parts of modified phase change powder.

The modified phase change powder was prepared by: heating and melting polyethylene glycol, adding expanded graphite to the melted polyethylene glycol in an amount of 5% by weight of the polyethylene glycol, then mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted polyethylene glycol can be absorbed by the expanded graphite completely to get a powder, then grinding the powder with a ball mill or a sand mill to obtain the modified phase change powder.

### Example 6

A phase change heat storage rubber, includes the following components in parts by weight: 40 parts of silicone rubber, 30 parts of modified phase change powder, and 10 parts of a nitrogen flame retardant.

The modified phase change powder was prepared by: heating and melting paraffin wax, adding nano silica micro powder to the melted paraffin wax in an amount of 12% by weight of the paraffin wax, then mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the nano silica micro powder completely to get a powder, then grinding the powder with a ball mill or a sand mill to obtain the modified phase change powder.

### Example 7

A phase change heat storage rubber, includes the following components in parts by weight: 40 parts of silicone rubber, 20 parts of modified phase change powder, and 10 parts of nitrogen flame retardant.

The modified phase change powder was prepared by: heating and melting a 10-carbon-atom alkane wax, adding hollow microsphere powder to the melted 10-carbon-atom alkane wax in an amount of 40% by weight of the 10-carbon-atom alkane wax, then mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 10-carbon-atom alkane wax can be absorbed by the hollow microsphere powder completely to get a powder, then grinding the powder with a ball mill or a sand mill to obtain the modified phase change powder.

### Example 8

A phase change heat storage rubber, includes the following components in parts by weight: 40 parts of silicone rubber, 30 parts of modified phase change powder, and 10 parts of nitrogen flame retardant.

The modified phase change powder was prepared by heating and melting fatty acid, adding nano silica micro powder to the melted fatty acid in an amount of 16% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the nano silica micro powder completely to get a powder, then grinding the powder with a ball mill or a sand mill to obtain the modified phase change powder.

### Example 9

A phase change heat storage rubber, includes the following components in parts by weight: 30 parts of NR (Natural Rubber) rubber, 20 parts of modified phase change powder, and 20 parts of a phosphorus flame retardant.

The modified phase change powder was prepared by heating and melting paraffin wax, adding nano silica micro powder to the melted paraffin wax in an amount of 22% by weight of the paraffin wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the nano silica micro powder completely to get a powder, then grinding the powder with a ball mill or a sand mill to obtain the modified phase change powder.

### Example 10

A phase change heat storage rubber, includes the following components in parts by weight: 30 parts of NR rubber, 20 parts of modified phase change powder, and 20 parts of phosphorus flame retardant.

The modified phase change powder was prepared by heating and melting 60-carbon-atom alkane wax, adding hollow microsphere powder to the melted 60-carbon-atom alkane wax in an amount of 6% by weight of the 60-carbon-atom alkane wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 60-carbon-atom alkane wax can be absorbed by the hollow microsphere powder completely to get a powder, then grinding the powder with a ball mill or a sand mill to obtain the modified phase change powder.

### Example 11

A phase change heat storage rubber, includes the following components in parts by weight: 30 parts of NR rubber, 20 parts of modified phase change powder, and 20 parts of phosphorus flame retardant.

The modified phase change powder was prepared by heating and melting fatty acid, adding nano silica micro powder to the melted fatty acid in an amount of 40% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the nano silica micro powder completely to get a powder, then grinding the powder with a ball mill or a sand mill to obtain the modified phase change powder.

### Example 12

A phase change heat storage rubber, includes the following components in parts by weight: 38 parts of NR rubber, 25 parts of modified phase change powder, and 18 parts of aluminum hydroxide.

The modified phase change powder was prepared by heating and melting PE wax, adding nano expanded graphite to the melted PE wax in an amount of 30% by weight of the PE wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted PE wax can be absorbed by the nano expanded graphite completely to get a powder, then grinding the powder with a ball mill or a sand mill to obtain the modified phase change powder.

### Example 13

A phase change heat storage rubber, includes the following components in parts by weight: 25 parts of NBR rubber, 12 parts of modified phase change powder, 12 parts of aluminum hydroxide, and 4 parts of graphite.

The modified phase change powder was prepared by heating and melting paraffin wax, adding nano silica micro powder to the melted paraffin wax in an amount of 28% by weight of the paraffin wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the nano silica micro powder completely to get a powder, then grinding the powder with a ball mill or a sand mill to obtain the modified phase change powder.

### Example 14

A phase change heat storage rubber, includes the following components in parts by weight: 25 parts of NBR rubber, 12 parts of modified phase change powder, 12 parts of aluminum hydroxide, and 4 parts of graphite.

The modified phase change powder was prepared by heating and melting 30-carbon-atom alkane wax, adding nano silica micro powder to the melted 30-carbon-atom alkane wax in an amount of 38% by weight of the 30-carbon-atom alkane wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 30-carbon-atom alkane wax can be absorbed by the nano silica micro powder completely to get a powder, then grinding the powder with a ball mill or a sand mill to obtain the modified phase change powder.

### Example 15

A phase change heat storage rubber, includes the following components in parts by weight: 25 parts of NBR rubber, 12 parts of modified phase change powder, 12 parts of aluminum hydroxide, and 4 parts of graphite.

The modified phase change powder was prepared by heating and melting fatty acid, adding nano silica micro powder to the melted fatty acid in an amount of 18% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the nano silica micro powder completely to get a powder, then grinding the powder with a ball mill or a sand mill to obtain the modified phase change powder.

### Example 16

A phase change heat storage rubber, includes the following components in parts by weight: 35 parts of NBR rubber, 15 parts of modified phase change powder, 15 parts of aluminum hydroxide, and 8 parts of boron nitride.

The modified phase change powder was prepared by heating and melting paraffin wax, adding expanded graphite to the melted paraffin wax in an amount of 8% by weight of the paraffin wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the expanded graphite completely to get a powder, then grinding the powder with a ball mill or a sand mill to obtain the modified phase change powder.

### Example 17

A phase change heat storage rubber, includes the following components in parts by weight: 35 parts of NBR rubber, 15 parts of modified phase change powder, 15 parts of aluminum hydroxide, and 8 parts of boron nitride.

The modified phase change powder was prepared by heating and melting 20-carbon-atom alkane wax, adding hollow microsphere powder to the melted 20-carbon-atom alkane wax in an amount of 18% by weight of the 20-carbon-atom alkane wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 20-carbon-atom alkane wax can be absorbed by the hollow microsphere powder completely to get a powder, then grinding the powder with a ball mill or a sand mill to obtain the modified phase change powder.

### Example 18

A phase change heat storage rubber, includes the following components in parts by weight: 35 parts of NBR rubber, 15 parts of modified phase change powder, 15 parts of aluminum hydroxide, and 8 parts of boron nitride.

The modified phase change powder was prepared by heating and melting fatty acid, adding nano silica micro powder to the melted fatty acid in an amount of 30% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the nano silica micro powder completely to get a powder, then grinding the powder with a ball mill or a sand mill to obtain the modified phase change powder.

### Example 19

A phase change heat storage rubber, includes the following components in parts by weight: 40 parts of silicone rubber, 30 parts of modified phase change powder, 10 parts of phosphorus flame retardant, and 18 parts of carbon nanotubes.

The modified phase change powder was prepared by heating and melting paraffin wax, adding hollow microsphere powder to the melted paraffin wax in an amount of 28% by weight of the paraffin wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the hollow microsphere powder completely to get a powder, then grinding the powder with a ball mill or a sand mill to obtain the modified phase change powder.

### Example 20

A phase change heat storage rubber, includes the following components in parts by weight: 40 parts of silicone rubber, 30 parts of modified phase change powder, 10 parts of phosphorus flame retardant, and 18 parts of carbon nanotubes.

The modified phase change powder was prepared by heating and melting 20-carbon-atom alkane wax, adding nano silica micro powder to the melted 20-carbon-atom alkane wax in an amount of 36% by weight of the 20-carbon-atom alkane wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 20-carbon-atom alkane wax can be absorbed by the nano silica micro powder completely to get a powder, then grinding the powder with a ball mill or a sand mill to obtain the modified phase change powder.

### Example 21

A phase change heat storage rubber, includes the following components in parts by weight: 40 parts of silicone rubber, 30 parts of modified phase change powder, 10 parts of phosphorus flame retardant, and 18 parts of carbon nanotubes.

The modified phase change powder was prepared by heating and melting fatty acid, adding expanded graphite to the melted fatty acid in an amount of 12% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the expanded graphite completely to get a powder, then grinding the powder with a ball mill or a sand mill to obtain the modified phase change powder.

### Example 22

A phase change heat storage rubber, includes the following components in parts by weight: 55 parts of silicone rubber, 33 parts of modified phase change powder, 15 parts of aluminum hydroxide, and 8 parts of boron nitride.

The modified phase change powder was prepared by heating and melting paraffin wax, adding hollow microsphere powder to the melted paraffin wax in an amount of 35% by weight of the paraffin wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the hollow microsphere powder completely to get a powder, then grinding the powder with a ball mill or a sand mill to obtain the modified phase change powder.

### Example 23

A phase change heat storage rubber, includes the following components in parts by weight: 55 parts of silicone rubber, 33 parts of modified phase change powder, 15 parts of aluminum hydroxide, and 8 parts of boron nitride.

The modified phase change powder was prepared by heating and melting 20-carbon-atom alkane wax, adding nano silica micro powder to the melted 20-carbon-atom alkane wax in an amount of 16% by weight of the 20-carbon-atom alkane wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 20-carbon-atom alkane wax can be absorbed by the nano silica micro powder completely to get a powder, then grinding the powder with a ball mill or a sand mill to obtain the modified phase change powder.

### Example 24

A phase change heat storage rubber, includes the following components in parts by weight: 55 parts of silicone rubber, 33 parts of modified phase change powder, 15 parts of aluminum hydroxide, and 8 parts of boron nitride.

The modified phase change powder was prepared by heating and melting fatty acid, adding expanded graphite to the melted fatty acid in an amount of 5% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the expanded graphite completely to get a powder, then grinding the powder with a ball mill or a sand mill to obtain the modified phase change powder.

### Example 25

A phase change heat storage rubber, includes the following components in parts by weight: 25 parts of EPDM rubber, 12 parts of modified phase change powder, 12 parts of aluminum hydroxide, and 4 parts of graphite.

The modified phase change powder was prepared by heating and melting paraffin wax, adding hollow microsphere powder to the melted paraffin wax in an amount of 25% by weight of the paraffin wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the hollow microsphere powder completely to get a powder, then grinding the powder with a ball mill or a sand mill to obtain the modified phase change powder.

### Example 26

A phase change heat storage rubber, includes the following components in parts by weight: 25 parts of EPDM rubber, 12 parts of modified phase change powder, 12 parts of aluminum hydroxide, and 4 parts of graphite.

The modified phase change powder was prepared by heating and melting 20-carbon-atom alkane wax, adding nano silica micro powder to the melted 20-carbon-atom alkane wax in an amount of 8% by weight of the 20-carbon-atom alkane wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 20-carbon-atom alkane wax can be absorbed by the nano silica micro powder completely to get a powder, then grinding the powder with a ball mill or a sand mill to obtain the modified phase change powder.

### Example 27

A phase change heat storage rubber, includes the following components in parts by weight: 25 parts of EPDM rubber, 12 parts of modified phase change powder, 12 parts of aluminum hydroxide, and 4 parts of graphite.

The modified phase change powder was prepared by heating and melting fatty acid, adding expanded graphite to the melted fatty acid in an amount of 15% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the expanded graphite completely to get a powder, then grinding the powder with a ball mill or a sand mill to obtain the modified phase change powder.

### Example 28

A phase change heat storage rubber, includes the following components in parts by weight: 60 parts of EPDM rubber, 40 parts of modified phase change powder, 30 parts of aluminum hydroxide, and 20 parts of aluminum oxide.

The modified phase change powder was prepared by heating and melting paraffin wax, adding hollow microsphere powder to the melted paraffin wax in an amount of 22% by weight of the paraffin wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted paraffin wax can be absorbed by the hollow microsphere powder completely to get a powder, then grinding the powder with a ball mill or a sand mill to obtain the modified phase change powder.

### Example 29

A phase change heat storage rubber, includes the following components in parts by weight: 60 parts of EPDM rubber, 40 parts of modified phase change powder, 30 parts of aluminum hydroxide, and 20 parts of aluminum oxide.

The modified phase change powder was prepared by heating and melting 20-carbon-atom alkane wax, adding nano silica micro powder to the melted 20-carbon-atom alkane wax in an amount of 8% by weight of the 20-carbon-atom alkane wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted 20-carbon-atom alkane wax can be absorbed by the nano silica micro powder completely to get a powder, then grinding the powder with a ball mill or a sand mill to obtain the modified phase change powder.

### Example 30

A phase change heat storage rubber, includes the following components in parts by weight: 60 parts of EPDM rubber, 40 parts of modified phase change powder, 30 parts of aluminum hydroxide, and 20 parts of aluminum oxide.

The modified phase change powder was prepared by heating and melting fatty acid, adding expanded graphite to the melted fatty acid in an amount of 6% by weight of the fatty acid, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted fatty acid can be absorbed by the expanded graphite completely to get a powder, then grinding the powder with a ball mill or a sand mill to obtain the modified phase change powder.

### Example 31

A phase change heat storage rubber, includes the following components in parts by weight: 50 parts of NR rubber, 30 parts of modified phase change powder, 20 parts of aluminum hydroxide, and 10 parts of aluminum oxide.

The modified phase change powder was prepared by heating and melting PE wax, adding nano silica micro powder to the melted PE wax in an amount of 10% by weight of the PE wax, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted PE wax can be absorbed by the nano silica micro powder completely to get a powder, then grinding the powder with a ball mill or a sand mill to obtain the modified phase change powder.

### Example 32

A phase change heat storage rubber, includes the following components in parts by weight: 40 parts of NR rubber, 20 parts of modified phase change powder, 20 parts of aluminum hydroxide, and 15 parts of carbon nanotubes.

The modified phase change powder was prepared by heating and melting polyethylene glycol, adding nano expanded graphite to the melted polyethylene glycol in an amount of 16% by weight of the polyethylene glycol, mixing the two components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted polyethylene glycol can be absorbed by the nano expanded graphite completely to get a powder, then grinding the powder with a ball mill or a sand mill to obtain the modified phase change powder.

### Example 33

A phase change heat storage rubber, includes the following components in parts by weight: 55 parts of CR rubber, 45 parts of polyethylene glycol, 22 parts of aluminum hydroxide, and 15 parts of expanded graphite.

A method for preparing a modified phase change powder could be: heating and melting the 45 parts of polyethylene glycol, adding the 15 parts of expanded graphite and the 22 parts of aluminum hydroxide to the melted polyethylene glycol, mixing the components to get a mixture, keeping the mixture warm in a water bath or an oil bath, the temperature may be 70° C.˜180° C., vibrating the mixture warmed in the water bath or the oil bath with a vibrating sieve for more than 4 hours, so that the melted polyethylene glycol can be absorbed by the nano expanded graphite completely to get a powder, then grinding the powder with a ball mill or a sand mill to obtain the modified phase change powder.

### Example 34

A method for preparing the phase change heat storage rubber, includes the following steps: after weighing all the components according to a formula,

step 1, mixing and banburying: mixing and banburying the rubber and the modified phase change powder for 0.5-3 h; and
step 2, extruding or compression molding to obtain the phase change heat storage rubber.

### Example 35

A method of using the phase change heat storage rubber described in Examples 1-33 includes using the phase change heat storage rubber in batteries and capacitors. The phase change heat storage rubber may be formed into a sheet or a frame, and is located between adjacent batteries or adjacent capacitors or between a core and a case of each battery and capacitor.

Tests are performed to the phase change heat storage rubbers described in Examples 1-12 when applied in the field of batteries, the results of which are shown in Table 1. The tested performance under the condition of the same ambient temperature, including specific heat capacity (SHC in short), enthalpy of phase change (referred to by A H), tensile strength (TS in short), flame retardant rating UL94 (UL 94 in short), were as follows (0.1 mm). Examples 1-12 are referred to by E1-E12.

TABLE 1

| | E 1 | E 2 | E 3 | E 4 | E 5 | E 6 | E 7 | E 8 | E 9 | E 10 | E 11 | E 12 |
|---|---|---|---|---|---|---|---|---|---|---|---|---|
| SHC | 2.53 | 2.56 | 2.51 | 2.9 | 2.6 | 2.51 | 2.55 | 2.58 | 2.7 | 2.7 | 2.7 | 2.58 |
| (J/ | | | | | | | | | | | | |
| (gK)) | | | | | | | | | | | | |
| Δ H | 37.2 | 38.1 | 39.2 | 39.2 | 37.2 | 43.5 | 44.2 | 43.8 | 49.6 | 50.1 | 50.8 | 34.6 |
| (J/g) | | | | | | | | | | | | |
| TS | 3.9 | 3.8 | 3.8 | 0.2 | 1.8 | 1.72 | 1.69 | 1.71 | 1.3 | 1.35 | 1.32 | 0.8 |
| (MPa) | | | | | | | | | | | | |
| UL94 | | | | | | V1 | V1 | V1 | V1 | V1 | V1 | V1 |

Tests are performed to the phase change heat storage rubbers described in Examples 13-33 when applied in the field of batteries, the results of which are shown in Table 2. The tested performance under the condition of the same ambient temperature, including specific heat capacity (SHC in short), enthalpy of phase change (referred to by H), tensile strength (TS in short), coefficient of thermal conductivity (referred to by K), flame retardant rating UL94 (UL 94 in short), breakdown voltage (BV in short), was as follows (0.1 mm). Examples 13-33 are referred to by E13-E33.

TABLE 2

| | E 13 | E 14 | E 15 | E 16 | E 17 | E 18 | E 19 | E 20 | E 21 | E 22 | |
|---|---|---|---|---|---|---|---|---|---|---|---|
| SHC (J/ | 2.49 | 2.48 | 2.49 | 2.85 | 2.87 | 2.9 | 2.6 | 2.6 | 2.6 | 2.55 | |
| (g · K)) | | | | | | | | | | | |
| Δ H | 25.3 | 25.9 | 26.8 | 30.2 | 30.9 | 3.18 | 39.6 | 40.2 | 41.3 | 38.2 | |
| (J/g) | | | | | | | | | | | |
| TS | 3.92 | 3.95 | 3.96 | 0.21 | 0.22 | 0.21 | 1.82 | 1.85 | 1.81 | 1.6 | |
| (MPa) | | | | | | | | | | | |
| K | 0.52 | 0.55 | 0.59 | 0.65 | 0.66 | 0.68 | 0.74 | 0.73 | 0.75 | 0.65 | |
| (W/mk) | | | | | | | | | | | |
| UL94 | V1 | V1 | V1 | V1 | V1 | V1 | V1 | V1 | V1 | V1 | |
| BV | >2K | >2K | >2K | >2K | >2K | >2K | >1K | >1K | >1K | >2K | |
| (KV/m | V | V | V | V | V | V | V | V | V | V | |
| m) | | | | | | | | | | | |
| | E 23 | E 24 | E 25 | E 26 | E 27 | E 28 | E 29 | E 30 | E 31 | E 32 | E 33 |
| SHC | 2.57 | 2.58 | 2.72 | 2.73 | 2.75 | 2.58 | 2.54 | 2.56 | 2.6 | 2.6 | 2.6 |
| (J/ | | | | | | | | | | | |
| (g · K)) | | | | | | | | | | | |
| Δ H | 38.9 | 38.3 | 32.8 | 32.6 | 33.1 | 34.6 | 35.6 | 35.7 | 37.2 | 37.5 | 37.6 |
| (J/g) | | | | | | | | | | | |
| TS | 1.59 | 1.58 | 1.58 | 1.61 | 1.6 | 0.8 | 0.85 | 0.88 | 1.81 | 1.82 | 1.81 |
| (MPa) | | | | | | | | | | | |
| K | 0.63 | 0.64 | 0.65 | 0.66 | 0.64 | 0.64 | 0.66 | 0.68 | 0.56 | 0.57 | 0.56 |
| (W/mk) | | | | | | | | | | | |
| UL94 | V1 | V1 | V1 | V1 | V1 | V1 | V1 | V1 | V1 | V1 | V1 |
| BV | >2K | >2K | >2K | >2K | >2K | >2K | >2K | >2K | >2K | >2K | >2K |
| (KV/m | V | V | V | V | V | V | V | V | V | V | V |
| m) | | | | | | | | | | | |

Tests are respectively performed to the phase change heat storage rubbers according to Examples 1-10 applied to an electric core, and a none-phase change rubber applied to an electric core, under the condition of discharging by 30 A at 1500 mAH for about 90 min, then the results are compared and the results are shown in Table 3:

TABLE 3

| Temperature rise | 1# | 2# | 3# | 4# | 5# | 6# | 7# | 8# | 9# | 10# | Average |
|---|---|---|---|---|---|---|---|---|---|---|---|
| None-phase | 63.0 | 69.8 | 66.5 | 66.3 | 68.0 | 70.8 | 71.7 | 69.1 | 67.5 | 69.2 | 68.18 |
| change (° | | | | | | | | | | | |
| C.) | | | | | | | | | | | |
| Phase | 51.7 | 63.0 | 64.0 | 63.4 | 61.0 | 49.1 | 59.4 | 49.1 | 49.8 | 49.0 | 55.94 |
| change | | | | | | | | | | | |
| rubber (° | | | | | | | | | | | |
| C.) | | | | | | | | | | | |

The results of the electric core tests show that the phase change material can significantly reduce the temperature of the electric core, and the average temperature can reach about 13° C.

It can be seen from Tables 1-3 that the phase change heat storage rubber of the present invention has a phase change enthalpy of about 15-200 J/g, a high endothermic value, a phase transition temperature of 28-85° C., a specific heat capacity ≥J/g·K, and a specific gravity reaching 0.9-1.6 g/cc; and when the addition amount of modified phase change powder increases, the specific heat capacity and phase change enthalpy also increase, and the rubber has a higher phase change enthalpy and a larger specific heat capacity, and in turn has better heat absorption and heat storage properties. It can be seen that the application of modified phase change powders combined provides the rubber with a surprising heat absorption enthalpy and specific heat capacity, and other performance indicators are also improved, with an unexpected enhancement effect. It was tested that the specific heat capacity also increases with the increase of the addition amount of modified phase change powder. However, when the amount of the modified phase change powder added is too large, the rubber is difficult to be molded and the mechanical properties are reduced, therefore, the ratio of the modified phase change powder preferably does not exceed the part by weight of the rubber.

To sum up, the phase change heat storage rubber of the present invention is more advantageous than the prior art in that: the phase change heat storage rubber herein contains a suitable amount of the modified phase change powder. The phase change enthalpy reaches 15-200 J/g, the specific heat capacity exceeds 2.0 J/g·K, satisfying the requirements of batteries and capacitors for heat absorption and heat storage performance. The modified phase change powder has heat absorption and energy storage functions. Because of a large phase change enthalpy value and a slow temperature rise, the rubber may absorb more heat. The heat generated at a heating point in the battery and capacitor is quickly transferred to the phase change heat storage rubber, so that the heating point is cooled faster, which can efficiently solve the technical problem of heating in the battery and capacitor. The phase change powder is modified by a modifier. The modifier is a powder that has a large specific surface area and contains micropores. After mixing with the modifier, the phase change powder has an enlarged specific surface area. The modifier powder contains a large number of micropores, and the phase change powder enters the micropores and is firmly locked, so the phase change powder cannot be freed from the micropores under high temperature conditions. This solves the problem that the phase change heat storage rubber may produce oil, not only improving the operability of the subsequent molding process, but more importantly, ensuring stable heat storage performance for a long time under high temperature conditions. The stability and sustainability of heat storage thereof are 4 to 5 times that of similar products on the market, and the heat storage performance thereof is reduced by no more than 2 to 3% even if in long term use.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A phase change heat storage rubber, comprising:
20-70 parts by weight of rubber; and
10-68 parts by weight of a modified phase change powder;
wherein a method for preparing the modified phase change powder comprises:
heating and melting a phase change powder to get a melted phase change powder;
adding a modifier to the melted phase change powder in an amount of 2%-40% by weight of the phase change powder to get a mixture;
keeping the mixture warm in a water bath or an oil bath;
vibrating the mixture warmed in the water bath or the oil bath with a vibrating sieve; and
grinding the mixture with a ball mill or a sand mill to obtain the modified phase change powder;
wherein the rubber is NBR;
wherein the phase change powder is any one or a combination of an alkane wax, fatty acid, a PE wax, and polyethylene glycol;
wherein the modifier is any one or a combination of expanded graphite, a nano silica micro powder, and a hollow microsphere powder.

2. The phase change heat storage rubber according to claim 1, further comprising 10 to 50 parts of a flame retardant that is one or a combination of a phosphorus-based flame retardant, a nitrogen-based flame retardant, and aluminum hydroxide.

3. The phase change heat storage rubber according to claim 1, further comprising 1 to 20 parts of a heat conductive powder that is one or a combination of alumina, boron nitride, aluminum nitride, and graphite.

4. The phase change heat storage rubber according to claim 1, further comprising 1 to 30 parts of graphite, carbon nanotubes, and/or graphene.

5. The phase change heat storage rubber according to claim 1, wherein a number of alkane carbon atoms of the alkane wax is between 10 and 60.

6. A method for preparing the phase change heat storage rubber according to claim 1, wherein the method comprises:
after weighing 20-70 parts by weight of rubber and 10-68 parts by weight of a modified phase change powder;
step 1, mixing and banburying: mixing and banburying the rubber and the modified phase change powder for 0.5-3 hours; and
step 2, extruding or compression molding to obtain the phase change heat storage rubber.

7. A method of using the phase change heat storage rubber according to claim 6, comprising using the phase change heat storage rubber in batteries and capacitors, the phase change heat storage rubber is configured between adjacent batteries or adjacent capacitors or between a core and a case of each battery and capacitor.
